(19) United States
(12) Patent Application Publication
(10) Pub. No.: US 2007/0055524 A1
(43) Pub. Date: Mar. 8, 2007

(54) Speech dialog method and device

(76) Inventors: Zhen-Hai Cao, Shanghai (CN); Jian-Cheng Huang, Mendham, NJ (US); Yi-Qing Zu, Shanghai (CN)

Correspondence Address: MOTOROLA, INC., 1303 EAST ALGONQUIN ROAD, IL01/3RD, SCHAUMBURG, IL, 60196, US

(21) Appl. No.: 11/222,215

(22) Filed: Sep. 8, 2005

(51) Int. Cl. G10L 15/18

(52) U.S. Cl. 704/257

(57) ABSTRACT

An electronic device (200) for speech dialog includes functions that receive (205, 105) an utterance that includes an instantiated variable (215), perform voice recognition (210, 115, 120) of the instantiated variable to determine a most likely set of acoustic states (220) and a corresponding sequence of phonemes with stress information (215), determine prosodic characteristics (272, 274, 276, 130) for a synthesized value of the instantiated variable (236) from the sequence of phonemes with stress information and a set of stored prosody models. The electronic device generates (335, 140) a synthesized value of the instantiated variable using the most likely set of acoustic states and the prosodic characteristics of the instantiated variable.

### FIELD OF THE INVENTION

The present invention is in the field of speech dialog systems, and more specifically in the field of confirmation of phrases spoken by a user.

### BACKGROUND

Current dialog systems often use speech as input and output modalities. A speech recognition function is used to convert speech input to text and a text to speech (TTS) function is used to present text as speech output. In many dialog systems, this TTS is used primarily to provide audio feedback to confirm a portion of the speech input, which may by accompanied by one of a small set of defined responses. This type of use may be called companion speech synthesis because the speech synthesis functions primarily as a companion to the speech recognition. For example, in some handheld communication devices, a user can use the speech input for name dialing. Reliability is improved when TTS is used to confirm the speech input. However, conventional confirmation functions that use TTS take a significant amount of time and resources to develop for each language and also consume significant amounts of memory resources in the handheld communication devices. This becomes a major problem for world-wide deployment of multi-lingual devices using such dialogue systems.

### BRIEF DESCRIPTION OF THE DRAWINGS

The present invention is illustrated by way of example and not limitation in the accompanying figures, in which like references indicate similar elements, and in which:

FIG. 1 is a flow chart that shows a speech dialog method in accordance with some embodiments of the present invention;

FIG. 2 is a block diagram of an electronic device that performs speech dialog, in accordance with some embodiments of the present invention;

FIG. 3 is a set of five graphs that show stored time varying normalized pitch models for syllables, in accordance with some embodiments of the present invention;

FIG. 4 is a set of five graphs that show stored time varying logarithmic energy models for voiced parts of a word or phrase, in accordance with some embodiments of the present invention;

FIG. 5 is a set of four graphs that show stored time varying logarithmic energy models for unvoiced parts of a word or phrase, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular embodiments of speech dialog systems in accordance with the present invention, it should be observed that the embodiments of the present invention reside primarily in combinations of method steps and apparatus components related to speech dialog systems. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

It will also be understood that the terms and expressions used herein have the ordinary meaning as is accorded to such terms and expressions with respect to their corresponding respective areas of inquiry and study except where specific meanings have otherwise been set forth herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A “set” as used in this document may mean an empty set. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, source code, object code, a shared library/dynamic load library and/or other sequence of instructions designed for execution on a computer system.

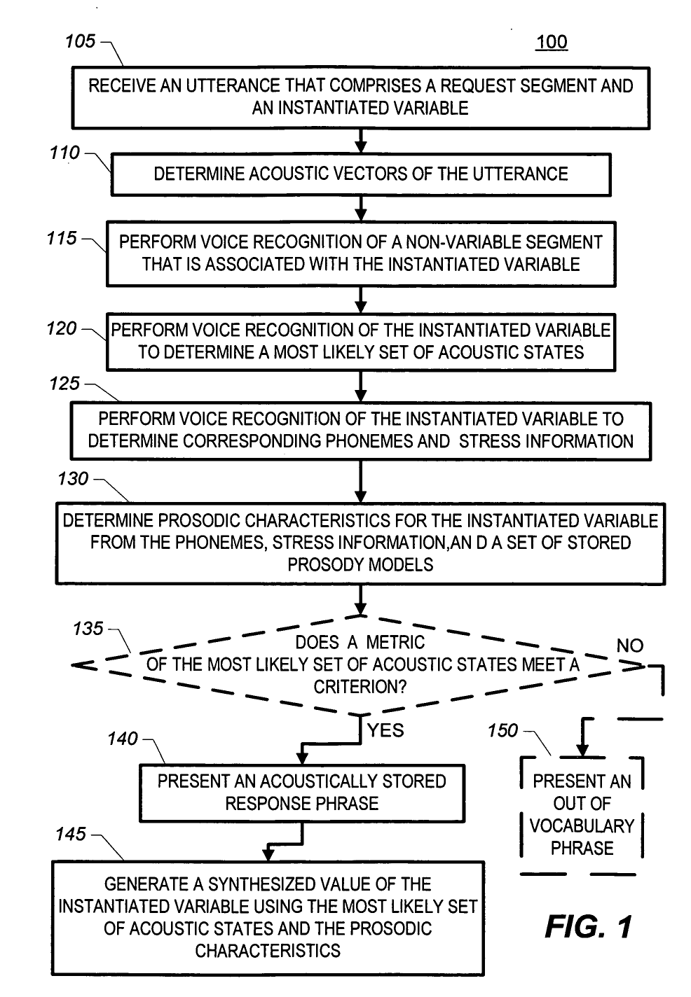

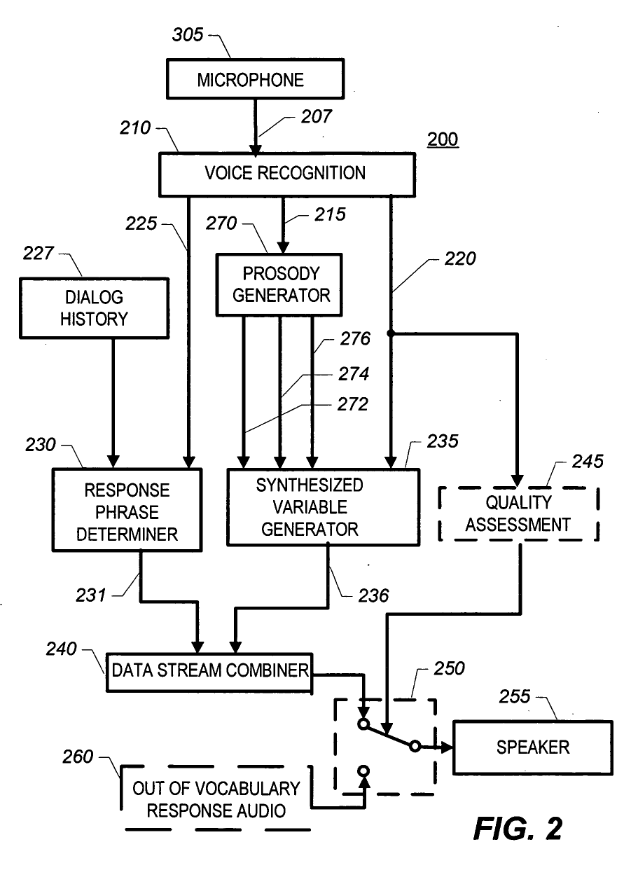

Referring to FIGS. 1, and 2 a flow chart 100 (FIG. 1) of some steps used in a method for speech dialog and a block diagram of an electronic device 200 (FIG. 2) are shown, in accordance with some embodiments of the present invention. Reference numbers used hereafter in the 100-199 range are shown in FIG. 1, while those in the 200-299 range are shown in FIG. 2. At step 105, a speech phrase (utterance) that is uttered by a user during a dialog is received by a microphone 205 of the electronic device 200 and converted to a sampled digital electrical signal 207 by the electronic device 200 using a conventional technique at a rate such as 22 kilo samples per second. The utterance comprises an instantiated variable, and may further comprise a non-variable segment, called a command segment. In one example, the utterance is “Dial Tom MacTavish”. In this utterance, “Dial” is word that is a non-variable segment (command segment) and “Tom MacTavish” is a name that is an instantiated variable (i.e., it is a particular value of a variable). The non-variable segment in this example is a command <Dial>, and the variable in this example has a variable type that is <dialed name>. The utterance may alternatively include no non-variable segments or more than one non-variable segment, and may include more than one instantiated variable. For example, in response to the received utterance described above, the electronic device may synthesize a response “Please repeat the name”, for which a valid utterance may include only the name, and no command segment. In another example, the utterance may be “Email the picture to Jim Lamb”. In this example, “Email” is a non-variable segment, “picture” is an instantiated variable of type <email object>, and “Jim Lamb” is an instantiated variable of the type <dialed name>.

The electronic device 200 stores mathematical models of sets of values of the variables and non-variable segments in a conventional manner, such as in a hidden Markov model (HMM). There may be more than one stored model, such as one for non-variable segments and one for each of several types of variables, or the stored model may be a combined model for all types of variables and non-variable segments. At step 110 (FIG. 1), a voice recognition function 210 (FIG. 2) of the electronic device 200 processes the digitized electronic signal 207 of the speech phrase at regular frame intervals, such as 10 milliseconds, and generates acoustic vectors of the utterance, as well as determining other characteristics of the frame intervals, such as energy. The voice recognition function is typically a speaker independent type of speech recognition function, although the technique described herein may provide benefits even when the speech recognition function 210 is of the speaker dependent type. The acoustic vectors may be converted to mel-frequency cepstrum coefficients (MFCC) or may be feature vectors of another conventional (or non-conventional) type. These may be more generally described as types of acoustic characteristics. Using a stored model of acoustic states that is derived from acoustic states for a set of values (such as Tom MacTavish, Tom Lynch, Steve Nowlan, Changxue Mass., . . . ) of at least one type of variable (such as <dialed name>) the voice recognition function 210 selects a set of acoustic states from the stored model that are most likely representative of the received acoustic vectors for each instantiated variable and non-variable segment (when a non-variable segment exists). In one example, the stored model is a conventional hidden Markov model (HMM), although other models could be used. In the more general case, the states that represent the stored values of the variables are defined such that they may be used by the mathematical model to find a close match to a set of acoustic characteristics taken from a segment of the received audio to a set of states that represents a value of a variable. Although the HMM model is widely used in conventional voice recognition systems for this purpose, other models (such as Gaussian Mixture Models) are known and other models may be developed; any of them may be beneficially used in embodiments of the present invention. The selected set of acoustic states for a non-variable segment identifies the value 225 (FIG. 2) of the non-variable segment. In the example given above, the value of “Dial” is identified. Note that the value may be something other than the text “Dial”, such as a predefined binary number. This completes voice recognition of the non-variable segment at step 115. The completion of step 115 may provide important information to the speech recognizer 210 that the next portion of the utterance comprises the instantiation of one or more variables.

The set of acoustic states that most likely represents an instantiated variable is termed the most likely set of acoustic states 220 (FIG. 2), which in some embodiments include sets of spectral vectors that may belong to mono-phone, bi-phone, or tri-phone units. The selection of the most likely set of acoustic states forms a part of voice recognition of the instantiated variable in which the most likely set of acoustic states of the instantiated variable are determined, at step 120. The speech recognizer also determines a sequence of phonemes that correspond to the most likely set of acoustic states, and stress information about the phonemes, at step 125. The stress information may be a set of stress values, wherein each stress value is related to an associated phoneme or an associated group of phonemes. The stress information and phonemes are then supplied to a prosody generator function 270, which uses one or more prosodic models to generate one or more prosodic values at step 130, such as pitch values 272, duration values 274, and energy values 276, in a manner described in more detail below.

In accordance with some embodiments, a response phrase determiner 230 (FIG. 2) determines a response phrase using the identified value 225 of the non-variable segment (when it exists in the voice phrase) in conjunction with a dialog history generated by a dialog history function 227 (FIG. 2). In the example described above, the non-variable value <Dial> has been determined and may be used without a dialog history to determine that the audio for a response phrase “Do you want to call” is to be generated. In some embodiments, a set of acoustic states for each value of response phrases are stored in the electronic device 200, and are used with stored pitch and voicing values to generate a digital audio signal 231 of the response phrase by conventional voice synthesis techniques, using a set of acoustic vectors and associated pitch and voicing characteristics. In other embodiments, digitized audio samples of the response phrases are stored and used directly to generate the digital audio signal 231 of the response phrase. The electronic device 200 may further comprise a synthesized variable generator 235 that generates a digitized audio signal 236 of a synthesized instantiated variable from the most likely set of acoustic states aligned with and modified by the pitch, duration, and energy factors 272, 274, 276 (or a subset of them that are generated in a particular embodiment) using these values and conventional techniques for combining the values.

A data stream combiner 240 sequentially combines the digitized audio signals of the response phrase and the synthesized instantiated variable in an appropriate order. During the combining process, the pitch and voicing characteristics of the response phrase may be modified from those stored in order to blend well with those used for the synthesized instantiated variable.

In the example described above, when the selected most likely set of acoustic states is for the value of the called name that is Tom MacTavish, the presentation of the response phrase and the synthesized instantiated variable, “Tom MacTavish” would typically be quite understandable to the user in most circumstances, allowing the user to affirm the correctness of the selection. On the other hand, when the selected most likely set of acoustic states is for a value of the called name that is, for example Tom Lynch, the presentation of the response phrase and the synthesized instantiated variable “Tom Lynch” would typically be harder for the user to mistake as the desired Tom MacTavish because not only was the wrong value selected and used, it is presented to the user in most circumstances with wrong pitch and voicing characteristics, allowing the user to more easily dis-affirm the selection. Essentially, by using the pitch, duration and energy values of the received phrase, differences are exaggerated between a value of a variable that is correct and a value of the variable that is phonetically close but incorrect, thereby improving reliability of the dialog.

In some embodiments, an optional quality assessment function 245 (FIG. 2) of the electronic device 200 determines a quality metric of the most likely set of acoustic states, and when the quality metric meets a criterion, the quality assessment function 245 controls a selector 250 to couple the digital audio signal output of the data stream combiner to an speaker function that converts the digital audio signal to an analog signal and uses it to drive a speaker. The determination and control performed by the quality assessment function 245 (FIG. 2) is embodied as optional step 135 (FIG. 1), at which a determination is made whether a metric of the most likely set of acoustic vectors meets a criterion. The aspect of generating the response phrase digital audio signal 231 (FIG. 2) by the response phrase determiner 230 is embodied as step 140 (FIG. 1), at which an acoustically stored response phrase is presented. The aspect of generating a digitized audio signal 236 of a synthesized instantiated variable using the most likely set of acoustic states and the pitch and voicing characteristics of the instantiated variable is embodied as step 145 (FIG. 1).

In those embodiments in which the optional quality assessment function 245 (FIG. 2) determines a quality metric of the most likely set of acoustic states, when the quality metric does not meet the criterion (i.e., fails), the quality assessment function 245 controls an optional selector 250 to couple a digitized audio signal from an out-of-vocabulary (OOV) response audio function 260 to the speaker function 255 that presents a phrase to a user at step 150 (FIG. 1) that is an out-of-vocabulary notice. For example, the out-of-vocabulary notice may be “Please repeat your last phrase”. In the same manner as for the response phrases, this OOV phrase may be stored as digital samples or acoustic vectors with pitch and voicing characteristics, or similar forms.

In embodiments not using a metric to determine whether to present the OOV phrase, the output of the data stream combiner function 240 is coupled directly to the speaker function 255, and steps 135 and 150 (FIG. 1) are eliminated.

The metric that is used in those embodiments in which a determination is made as to whether to present an OOV phrase may be a metric that represents a confidence that a correct selection of the most likely set of acoustic states has been made. For example, the metric may be a metric of a distance between the set of acoustic vectors representing an instantiated variable and the selected most likely set of acoustic states.

As indicated above with particular reference to generating the synthesized value of the instantiated variable at step 130 (FIG. 1) using the prosody generator 270, a sequence of phonemes that correspond to the most likely set of acoustic states, and stress information about the phonemes are received by the prosody generator function 270 from the voice recognition function 210. As is well known to those of ordinary skill in the art, each word comprises one or more syllables, which in turn one or more phonemes. Each syllable has one of three word position attributes, which are identified herein as:

1. Ws: The syllable in a single syllable word.

2. Wo: The syllables in a multi-syllable word except the last syllable in the multi-syllable word.

3. Wf: The last syllable in a multi-syllable word.

It is also well known that within a syllable, phonemes are grouped closely. Each syllable has its own pattern of phoneme structure, such as: v, c+v, v+c, or c+v+c, wherein:

c: consecutive consonants;

s: consecutive sonant phonemes, including semi-vowel, nasal or glide sounds; and

v: consecutive vowels.

Three syllable position attributes are defined for vowels. They are:

1. SS: The vowel phoneme in single vowel syllable.

2. SO: The vowel phonemes in multi-vowel syllable except the last vowel phoneme in a multi-vowel syllable.

3. SF: The last vowel phoneme in a multi-vowel syllable.

Four syllable position attributes are defined for consonants. They are:

1. LS The first consonant phoneme at the beginning of a syllable.

2. LO: A consonant phoneme at the beginning of a syllable except 1.

3. TS: The last consonant phoneme at the end of a syllable.

4. TO: A consonant phoneme at the end of a syllable except 3.

An exemplary set of prosodic models is now described, using the above definitions.

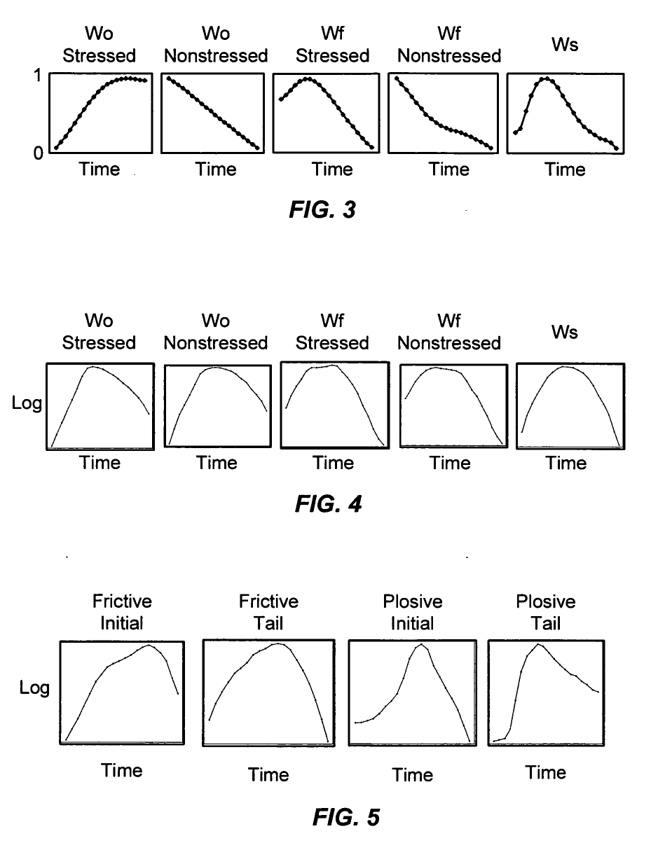

Referring to FIG. 3, five graphs show stored time varying normalized pitch models for the voiced parts of syllables, in accordance with some embodiments of the present invention. One normalized pitch model is selected and used to modify the pitch of a syllable that includes one or more corresponding phonemes of the set of most likely states 220 This keeps the stress/unstressed accents in the correct places in words and maintains word prosody. Experiments show that phoneme positions within a syllable affect syllable pitch contour slightly, but that a syllable's pitch contour mainly depends on its word position and whether it is a stressed syllable or not. Based on the above definition of word positions and the stress information associated with the phoneme or phonemes of the syllable, a selection of one of five stored patterns of pitch contour, when used in conjunction with selected energy and duration models, is found to be sufficient to provide a natural sounding synthesized syllable. The five normalized pitch models are defined in one embodiment as:

1. Wo Stressed.

2. Wo Nonstressed.

3. Wf Stressed.

4. Wf Nonstressed.

5. Ws (The one syllable is always stressed)

For example, here are two words:

barry b'ae-riy

toler t'ow-ler

Where the single apostrophe stands for the lexical stress. The syllable “b'ae” and “t'ow” share the same pitch pattern “Wo Stressed” and syllable “riy” and “ler” share the same pitch model “Wf Nonstressed”. When using the same pitch pattern, the only difference between two syllables may be the length of their pitch contour, which depends on the duration of voiced phonemes (described below).

Referring to FIG. 4, five graphs show stored time varying logarithmic energy models for voiced parts of a syllable, in accordance with some embodiments of the present invention. For energy modeling, different strategies are used for voiced part and un-voiced part. For voiced parts of the utterance, one logarithmic energy model is selected and used to modify the energy of a syllable that includes one or more corresponding phonemes of the set of most likely states 220, which keeps the stress/unstressed accents in the correct places in words and maintains word prosody. Experiments show that a voiced syllable's energy contour mainly depends on its word position and whether it is a stressed syllable or not. In a manner similar to the pitch model, a selection of one of five stored patterns of energy contour, when used in conjunction with selected pitch and duration models, is found to be sufficient to provide a natural sounding synthesized voiced syllable. The five normalized energy models for voiced part of the utterance are defined in one embodiment as:

1. Wo Stressed.

2. Wo Nonstressed.

3. Wf Stressed.

4. Wf Nonstressed.

5. Ws (The one syllable is always stressed)

Referring to FIG. 5, four graphs show stored time varying logarithmic energy models for unvoiced parts of a syllable, in accordance with some embodiments of the present invention. For unvoiced parts of the utterance, one logarithmic energy model is selected and used to modify the energy of a phoneme of the set of most likely states 231. Each un-voiced phoneme has an energy contour pattern that depends on its position within syllable and syllable position in a word. Also to reduce memory, some un-voiced phonemes can share the same energy contour pattern at the same position. For example, phoneme “s”, “sh” and “ch” share the same energy contour, while “g”, “d” and “k” share the same energy contour pattern. In an unvoiced phoneme, such as a consonant initial phoneme (for example, t in t'axn), and consonant tail phoneme (for example, t in ‘iht), there are several classes: plosive, fricative, affricate and whisper. Each class has two energy models, one for initial (at the initial of a syllable) and one for tail position (at the tail of a syllable). An exemplary set of energy models for plosive frictive phonemes at the initial and tail positions of a syllable are shown in FIG. 5. The models for other classes (affictive and whisper) can be determined by experimentation in which the energy contour of phonemes is measured using instances of the classes.

Each phoneme has a variable duration. A phoneme's duration depends on not only its position within a syllable but also its syllable position in a word. As mentioned above, three word position attributes, three vowel syllable positions and four consonant positions are defined. Also, a syllable may be stressed or unstressed. Therefore, each phoneme can have one of several duration values, depending on position attributes and the stressed status.

For example, here is a duration table for phoneme “er”:

| | | Phoneme | |
|---|---|---|---|
| Stressed | Syllable Position | Position in | |
| status | in word | syllable | Duration (10 ms) |
| Stressed | WS | SS | 23 |
| Stressed | WS | SO | 18 |
| Stressed | WS | SF | 21 |
| Stressed | WO | SS | 14 |
| Stressed | WO | SO | 11 |
| Stressed | WO | SF | 13 |
| Stressed | WF | SS | 21 |
| Stressed | WF | SO | 16 |
| Stressed | WF | SF | 19 |
| Unstressed | WO | SS | 11 |
| Unstressed | WO | SO | 8 |
| Unstressed | WO | SF | 10 |
| Unstressed | WF | SS | 15 |
| Unstressed | WF | SO | 11 |
| Unstressed | WF | SF | 13 |

The durations for other phonemes can be determined by experimentation in which the duration of phonemes is measured using instances of the classes.

By the use of these prosodic models, the necessary prosodic information is obtained in very limited memory resources. It will be appreciated that the stored models may be stored as a table of point values that are used in a known manner to modify the pitch of the set of most likely acoustic states that represent a syllable, or they may alternatively be stored in the form of constants that are used as factors and/or exponents in a formula that generates a time varying set of outputs that are used in a known manner to modify the pitch of the set of most likely acoustic states that represent the syllable. It will also be appreciated that the number of models could be changed (for example, decreased slightly) and the invention would still provide some of the benefits described herein.

The embodiments of the speech dialog methods 100 and electronic device 200 described herein may be used in a wide variety of electronic apparatus such as, but not limited to, a cellular telephone, a personal entertainment device, a pager, a television cable set top box, an electronic equipment remote control unit, an portable or desktop or mainframe computer, or an electronic test equipment. The embodiments provide a benefit of less development time and require fewer processing resources than prior art techniques that involve speech recognition down to a determination of a text version of the most likely instantiated variable and the synthesis from text to speech for the synthesized instantiated variable. These benefits are partly a result of avoiding the development of the text to speech software systems for synthesis of the synthesized variables for different spoken languages for the embodiments described herein.

It will be appreciated the speech dialog embodiments described herein may be comprised of one or more conventional processors and unique stored program instructions that control the one or more processors to implement, in conjunction with certain non-processor circuits, some, most, or all of the functions of the speech dialog embodiments described herein. The unique stored programs may be conveyed in a media such as a floppy disk or a data signal that downloads a file including the unique program instructions. The non-processor circuits may include, but are not limited to, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, in which each function or some combinations of certain of the functions are implemented as custom logic. Of course, a combination of the two approaches could be used. Thus, methods and means for these functions have been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. Some aspects of the embodiments are described above as being conventional, but it will be appreciated that such aspects may also be provided using apparatus and/or techniques that are not presently known. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for speech dialog, comprising:
receiving an utterance that includes an instantiated variable;
performing voice recognition of the instantiated variable to determine a most likely set of acoustic states and a corresponding sequence of phonemes with stress information;
determining prosodic characteristics for a synthesized value of the instantiated variable from the corresponding sequence of phonemes with stress information and a set of stored prosody models; and
generating a synthesized value of the instantiated variable using the most likely set of acoustic states and the prosodic characteristics.

2. The method for speech dialog according to claim 1, wherein the set of stored prosody models includes speech unit models for pitch, energy, and duration.

3. The method for speech dialog according to claim 1, wherein the performing of the voice recognition of the instantiated variable comprises:
determining acoustic characteristics of the instantiated variable; and
using a mathematical model of stored values and the acoustic characteristics to determine the most likely set of acoustic states and the corresponding sequence of phonemes.

4. The method for speech dialog according to claim 3, wherein the mathematical model of stored lookup values is a hidden Markov model.

5. An electronic device for speech dialog, comprising:
means for receiving an utterance that includes an instantiated variable;
means for performing voice recognition of the instantiated variable to determine a most likely set of acoustic states and a corresponding sequence of phonemes with stress information;
means for determining prosodic characteristics for a synthesized value of the instantiated variable from the corresponding sequence of phonemes with stress information and a set of stored prosody models; and
means for generating a synthesized value of the instantiated variable using the most likely set of acoustic states and the prosodic characteristics.

6. The electronic device for speech dialog according to claim 5, wherein the set of stored prosody models includes speech unit models for pitch, energy, and duration.

7. The electronic device for speech dialog according to claim 5, wherein the means for performing voice recognition of the instantiated variable comprises:
means for determining acoustic characteristics of the instantiated variable; and
means for using a stored model of acoustic states and the acoustic characteristics to determine the most likely set of acoustic states and the corresponding sequence of phonemes.

8. The electronic device for speech dialog according to claim 5, wherein generating the synthesized value of the instantiated variable is performed when a metric of the most likely set of acoustic states meets a criterion, and further comprising:
means for presenting an acoustically stored out-of-vocabulary response phrase when the metric of the most likely set of acoustic states fails to meet the criterion.

9. A media that includes a stored set of program instructions, comprising:
a function for receiving an utterance that includes an instantiated variable;
a function for performing voice recognition of the instantiated variable to determine a most likely set of acoustic states and a corresponding sequence of phonemes with stress information;
a function for determining prosodic characteristics for a synthesized value of the instantiated variable from the sequence of phonemes with stress information and a set of stored prosody models; and
a function for generating a synthesized value of the instantiated variable using the most likely set of acoustic states and the prosodic characteristics.

10. The media according to claim 9, wherein the set of stored prosody models includes speech unit models for pitch, energy, and duration.

11. The media according to claim 9, wherein the function for performing the voice recognition of the instantiated variable comprises:
a function for determining acoustic characteristics of the instantiated variable; and
a function for using a mathematical model of stored lookup values and the acoustic characteristics to determine the most likely set of acoustic states and the corresponding sequence of phonemes.

12. The method for speech dialog according to claim 9, wherein the mathematical model of stored lookup values is a hidden Markov model.

13. The media according to claim 9, wherein the function of generating the synthesized value of the instantiated variable is performed when a metric of the most likely set of acoustic states meets a criterion, and further comprising:
a function for presenting an acoustically stored out-of-vocabulary response phrase when the metric of the most likely set of acoustic states fails to meet the criterion.
